(19) United States
(12) Patent Application Publication
(10) Pub. No.: US 2014/0209702 A1
(43) Pub. Date: Jul. 31, 2014

(54) MIST SPRAYING DEVICE

(71) Applicant: FULL MOST CO., LTD., New Taipei City (TW)

(72) Inventors: Ming-Chun WENG, New Taipei City (TW); Ming-Tsang YU, New Taipei City (TW); Wen-Pin PEN, New Taipei City (TW); Chia-Neng YANG, New Taipei City (TW)

(73) Assignee: FULL MOST CO., LTD., New Taipei City (TW)

(21) Appl. No.: 13/830,985

(22) Filed: Mar. 14, 2013

(30) Foreign Application Priority Data
Jan. 30, 2013 (TW) 102103635

(51) Int. Cl. B05B 12/00

(52) U.S. Cl. CPC B05B 12/004
USPC 239/74

(57) ABSTRACT

A mist spraying device includes a base having a control circuit and a battery, a water tank having an atomizing plate and a water level sensor, and an upper lid. The top of the base includes metal junctions connected with a power end and a sensor end of the control circuit. The water tank is connected to an upper end of the base, and a bottom of the water tank includes conductor junctions, enabling the control circuit to control the atomizing plate to atomize by oscillation water or liquid in the water tank into water steam or gasified liquid to be sprayed out. The upper lid is assembled with the base, covers the water tank, and includes a spraying hole to spray out water steam or gasified liquid formed by atomizing water or liquid in the water tank by the atomizing plate.

### BACKGROUND OF THE INVENTION

a) Field of the Invention

The present invention relates to a mist spraying device, and more particularly to a mist spraying device which is carried personally to spray water steam or gasified liquid into a mouth or a nose, and is provided with an atomizing plate and a water level sensor to spray the mist by oscillation and to sense the water level. In addition, the mist spraying device is also provided with a separable water tank that can be assembled with the mist spraying device.

b) Description of the Prior Art

Most of the conventional mist spraying devices that are carried personally are formed by a cylinder filled with pressurized gas or air, and a compressible spray head. For example, a Taiwanese Invention Patent No. 355358, “Spray Head Device,” discloses a conventional cylinder filled with pressurized gas or air. The cylinder contains medicine or liquid, and when the spray head is pressed down, the pressurized gas or air will atomize and spray out the medicine or liquid. For this kind of conventional mist spraying device that is carried personally, as the cylinder is filled with the pressurized gas or air, it is easily affected by environmental temperature or deformation from collision to result in a danger of accidental explosion.

Accordingly, an improved mist spraying device is provided. For example, a Taiwanese Utility Model Patent Publication No. 338515, “Wrist-Type Real-Time Mist Spraying Device,” discloses a technology to install a personal mist spraying device on a wrist. Nevertheless, the personal mist spraying device on the wrist is still a design of pressure tank, and therefore, still exists the issue that the abovementioned pressure tank is easily affected by environmental temperature or collision to result in a danger of explosion to the pressure tank. In particular, if the pressure tank stores some harmful substance, such as tear gas, it can even endanger a user's safety directly.

On the other hand, a Taiwanese Utility Model Patent No. M417925, “Portable Atomization Device,” discloses a technology that uses an electromagnetic device and a magnet to control spraying of atomized liquid. However, as the magnet is used to control spraying, it is easily interfered by strong magnetic fields in the environment to result in a chance of an error action or malfunctioning. Besides that, as there is no liquid level control and alert device in the atomization device, when the atomization liquid in the load chamber is used up, the atomization element can be easily burnt out by vacant combustion.

### SUMMARY OF THE INVENTION

Accordingly, the primary object of present invention is to provide a mist spraying device to improve the problems and shortcomings of the conventional personal mist spraying device which sprays the mist by pressure of gas or uses a magnet to control spraying, that the cylinder and the pressure tank can be exploded easily, the mist spraying device can have an error action or be malfunctioning by electromagnetic interference, or the atomization element can be burnt out by vacant combustion.

To achieve the abovementioned object, the mist spraying device of the present invention includes a base that is provided with a control circuit and a battery, a water tank that is provided with an atomizing plate and a water level sensor, and an upper lid. A periphery on a top of the base is provided with an illumination device that displays a condition of spraying, electricity of the battery or the water level, under a control of the control circuit. The top of the base is provided with plural metal junctions to connect with a power end and a sensor end of the control circuit. The water tank is connected to an upper end of the base and a bottom of the water tank is provided with plural conductor junctions to connect with the atomizing plate and the water level sensor. Through contact and connection between the conductor junctions and the metal junctions on the top the base, the atomizing plate can be controlled by the control circuit to atomize water or liquid in the water tank into water steam or gasified liquid by oscillation, and to spray out the water steam or gasified liquid. The upper lid is assembled at the base and covers an exterior of the water tank. In addition, the upper lid is provided with at least a spraying hole to spray out the water steam or gasified liquid after the water or liquid has been atomized by the atomizing plate of the water tank.

The effect of the mist spraying device of the present invention lies in that as the water tank and the base can be separated apart and assembled together, liquid in the water tank can be replaced and filled individually. In addition, an interior of the water tank is provided with the atomizing plate and the water level sensor, the water or liquid in the tank can be atomized by oscillation and then sprayed out, which is safer than the cylinder with pressurized gas or the wrist-type mist spraying device. Furthermore, the water level sensor in the water tank can sense the water level to allow the control circuit in the base to be aware of the water level in that tank precisely, and control the atomizing plate to operate absolutely safely and accurately, without the problems and shortcomings that the atomizing plate takes an error action or is malfunctioning by the interference of magnetic fields or the atomizing plate is burnt out by vacant combustion.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional structural view of appearance of a mist spraying device of the present invention.

FIG. 2 shows a three-dimensional exploded structure view of the mist spraying device of the present invention.

FIG. 3 shows a three-dimensional view of a rear-view angle of a base, according to the mist spraying device of the present invention.

FIG. 4 shows a schematic view of an operation to assemble a water tank with the base, according to the mist spraying device of the present invention.

FIG. 5 shows a schematic view of another operation to assemble the water tank with the base, according to the mist spraying device of the present invention.

FIG. 6 shows a local exploded structure view of the mist spraying device of the present invention, manifesting an atomizing plate, a waterproof washer and a panel that are assembled at a seal portion of an exit of the water tank.

### DETAILED DESCRIPTION OF THE PREFERRED EMBODIMENTS

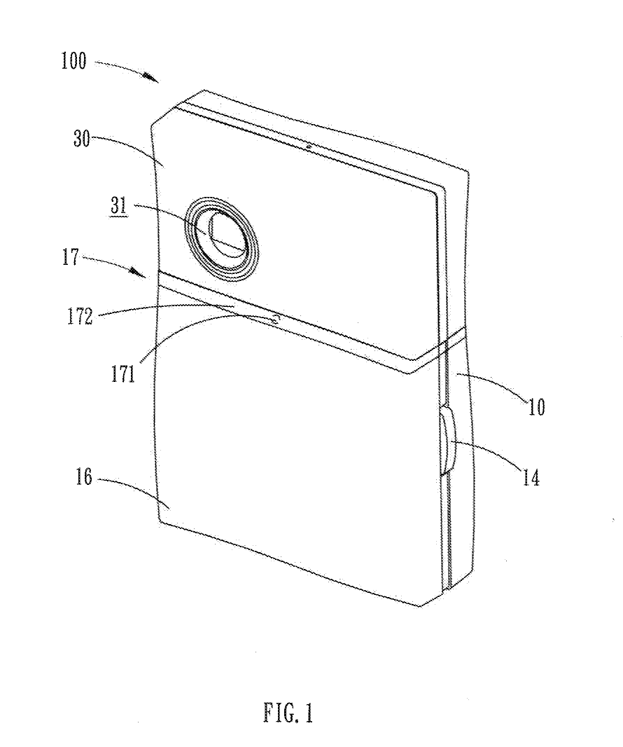

Referring to FIGS. 1 to 3, a mist spraying device 100 of the present invention comprises a base 10. An interior of the base 10 is provided with a control circuit 11 and a battery chamber 12. The control circuit 11 is equipped with control functions of atomizing by oscillation, sensing water level and displaying conditions. An interior of the battery chamber 12 is provided with at least one battery 121 to provide required working power to the control circuit 11 by electricity of the battery 121.

Two sides of the base 10 are provided respectively with a switch 13, an elastic button 14 and plural latch holes 15. The switch 13 is connected with the control circuit 11 and can be pressed down to control the control circuit 11 to activate the control function of atomizing by oscillation. The elastic button 14 is provided with functions of elastic deformation and elastic restoration when being pressed down.

A front side of the base 10 is assembled with a rear cover 16, and a side of the rear cover 16 is provided with plural claws 161. The claws 161 are engaged into the latch holes 15 on a side of the base 10, and the other side of the rear cover 16 forms a latch group with the elastic button 14. When the rear cover 16 needs to be taken down, a user only needs to press down the elastic button 14 to result in elastic deformation that the elastic button 14 can be escaped from one side of the rear cover 16, allowing the rear cover 16 to be dismantled from the base 10 to replace the battery 121 in the battery chamber 12 or to maintain the control circuit 11.

A periphery at a top of the abovementioned base 10 is provided with an illumination device 17. There is no limit to the type of the illumination device 17, and in the present invention, the illumination device 17 is formed by at least a light emitting diode 171 and a light guide plate 172. However, other equivalent illumination devices are also acceptable. The light emitting diode 171 is connected with the control circuit 11 and is controlled by the control circuit 11 to display a condition of spraying of water steam or gasified liquid, electricity of the battery 121 or water level. In addition, the light emitting diode 171 can display the condition of atomizing by oscillation, electricity or water level by a different color or flashing.

The top of the abovementioned base 10 is provided with plural metal junctions 18, a latch pole 19, a latch slot 191 and plural elastic latch buttons 192, 193. The metal junctions 18 can be pressed down and restored elastically. The metal junctions 18 are connected respectively to a power end and a sensor end of the control circuit 11 to output power and input a sensor signal of water level. Two sides of the latch pole 19 are provided respectively with a bump 19a, 19b. There is no limit to the shape of the latch slot 191, and in the present invention, the latch slot 191 is an arc-shaped groove. The elastic latch buttons 192, 193 can be deformed and restored when being pressed down.

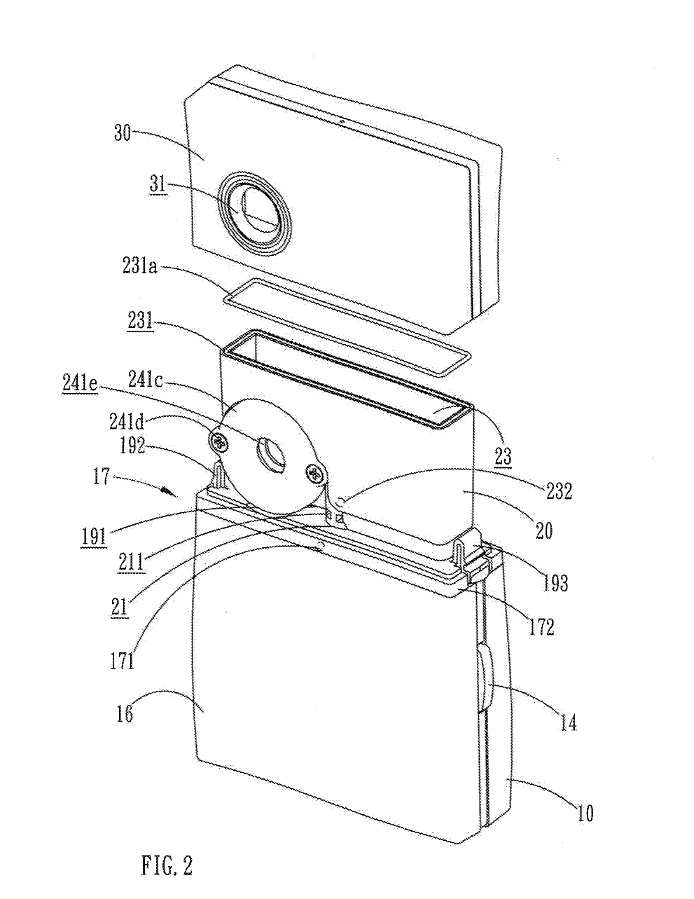

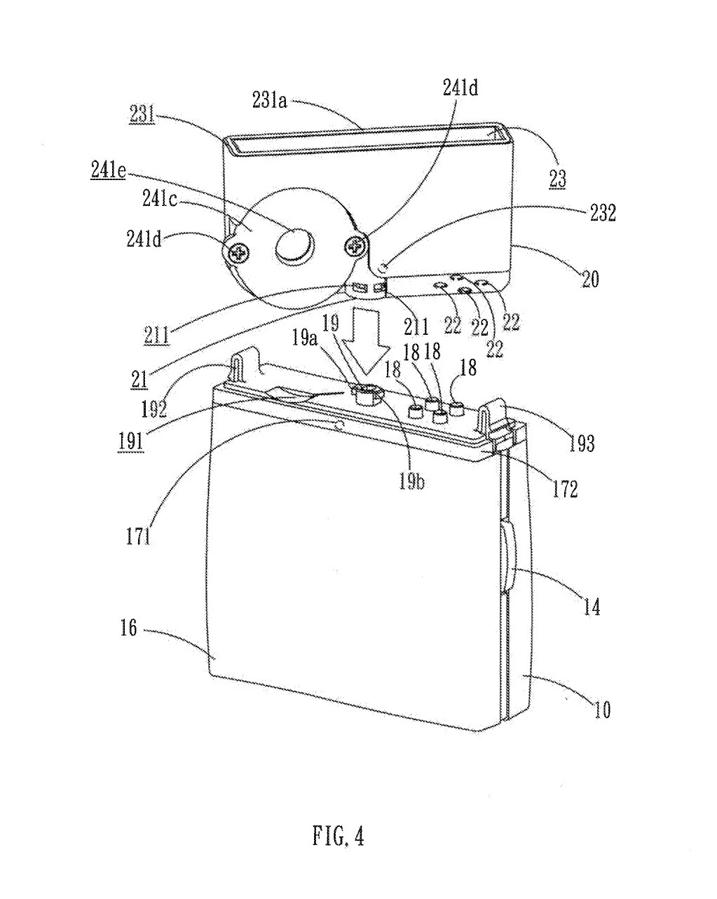

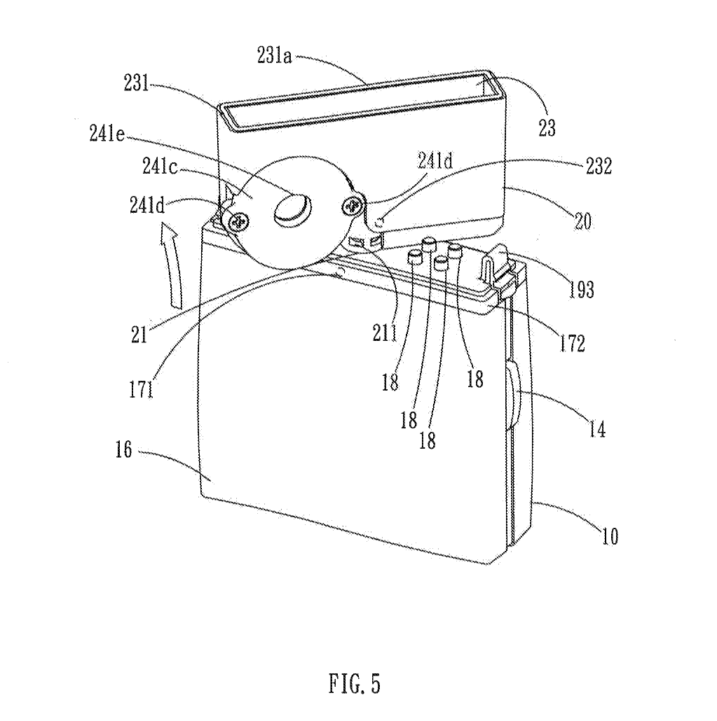

Referring to FIG. 4 and FIG. 5, a water tank 20 is provided at a bottom with a latch opening 21 and plural conductor junctions 22. A periphery of the latch opening 21 is provided with plural openings 211, and the latch opening 21 can be latched with the latch pole 19 on the top of base 10 in a downward and oblique direction (as shown in FIG. 4). Next, the water tank 20 is turned clockwise by a certain circumferential angle against the latch pole 19 (as shown in FIG. 5), allowing the bumps 19a, 19b of the latch pole 19 to be latched into the openings 211 of the latch opening 21, and enabling a side at a bottom of the water tank 20 to be latched into the latch slot 191 on the top of the base 10, so that the water tank 20 can be stably assembled on the top of the base 10 (as shown in FIG. 2), and the conductor junctions 22 can be connected with the metal junctions 18 on the top of the base 10. On the other hand, when the water tank 20 is to be removed, the water tank 20 can be turned counterclockwise by a certain circumferential angle, so that a side of the bottom of the water tank 20 can be escaped from the latch slot 191 on the top of the base 10, the bumps 19a, 19b of the latch pole 19 can be escaped from the openings 211 of the latch opening 21, and then the water tank 20 can be pulled upward. The described operation is opposite to that in FIG. 4 and FIG. 5.

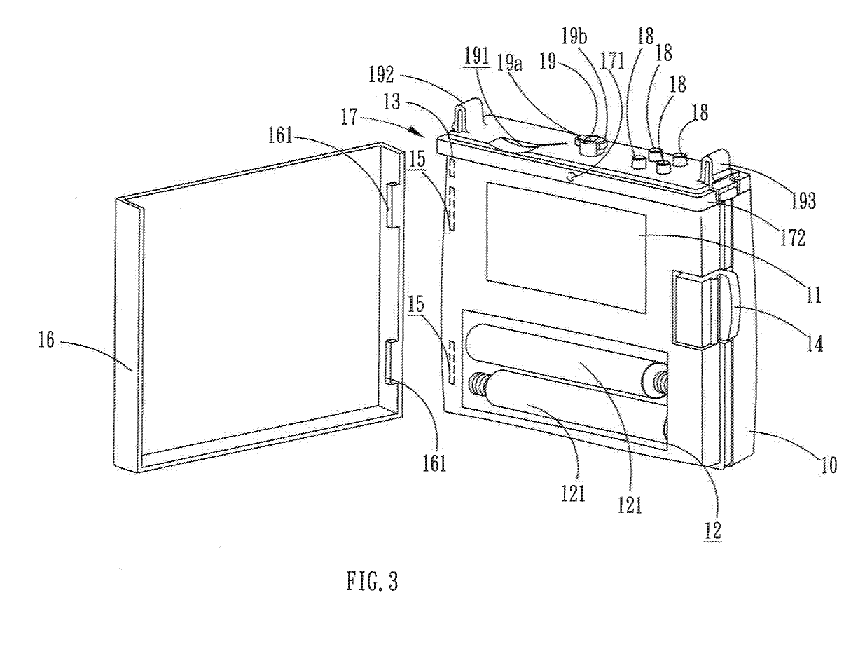

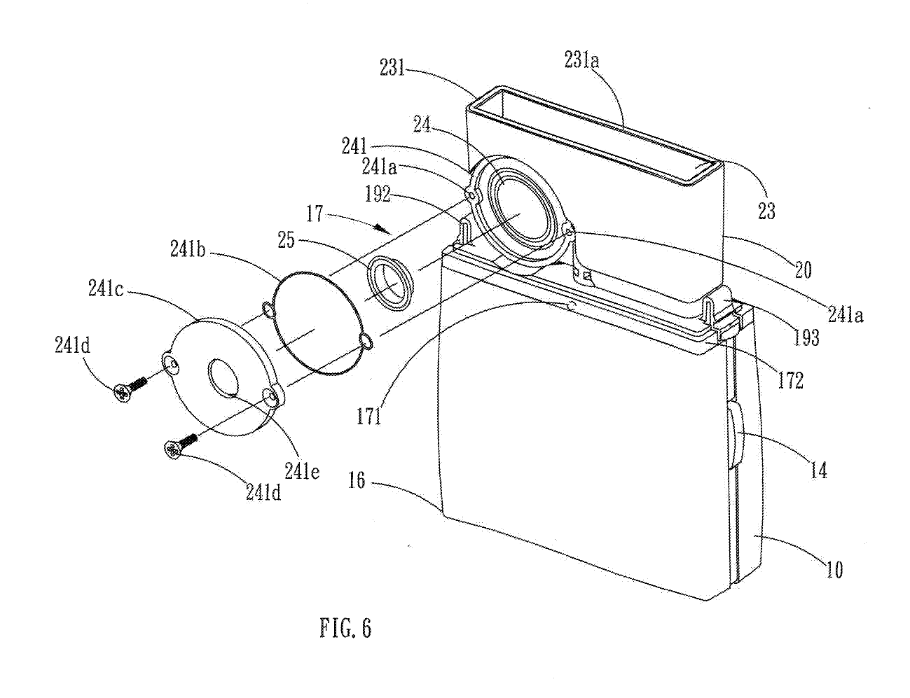

Referring to FIG. 4 and FIG. 6, an interior of the abovementioned water tank 20 is provided with a containing sink 23 which can hold water or liquid. A top of the containing sink 23 is provided with a leak-proof hole 231, and an interior of the leak-proof hole 231 is assembled with a waterproof gasket 231a to prevent water or liquid in the containing sink 23 from overflowing or exuding. An interior of the containing sink 23 is provided with a water level sensor 232 to sense water level or liquid level in the containing sink 23. In addition, the water level sensor 232 is connected by a wiring with the conductor junctions 22 on the bottom of the water tank 20, and is connected with the metal junctions 18 on the top of the base 10 through the abovementioned conductor junctions 22, thereby outputting a sensed condition of water level or liquid level to the control circuit 11 (as shown in FIG. 3), so that the control circuit 11 can be aware of the water level or liquid level in the containing sink 23 of the water tank 20.

An exterior of the water tank 20 is provided with at least an exit 24 which is connected to the containing sink 23. The exit 24 is assembled with an atomizing plate 25 to atomize by oscillation water or liquid in the containing sink 23 through electricity, and then to spray out the atomized water or liquid. The atomizing plate 25 is connected by a wiring with the conductor junctions 22 on the bottom of the water tank 20, and is connected with the metal junctions 18 on the top of the base 10 through the conductor junctions 22, enabling the control circuit 11 (as shown in FIG. 3) of the base 10 to control the atomizing plate 25 to operate atomization of the water or liquid.

A periphery of the exit 24 is provided at least with a seal portion 241 on which are provided with plural screw holes 241a. The seal portion 241 is attached respectively with a waterproof washer 241b and a panel 241c, and then is locked with the screw holes 241a by plural bolts 241d, so that the waterproof washer 241b and the panel 241c can be fixed and assembled on the seal portion 241. The panel 241c is provided with an ejection hole 241e to output the atomized water or liquid.

An upper lid 30 (as shown in FIG. 2) is latched with exterior sides of the elastic latch buttons 192, 193 on the top of the base 10, so that the upper lid 30 can be assembled on the top of the base 10 and covers an exterior of the water tank 20. An exterior of the upper lid 30 is provided at least with a spraying hole 31 which corresponds to the ejection hole 241e on the panel 241c of the water tank 20, so that the atomized water or liquid that is outputted from the ejection hole 241e can be sprayed out from the spraying hole 31.

Upon practically using the mist spraying device 100 as shown in FIGS. 1 to 6, the switch 13 on a side of the base 10 can be pressed down to enable the control circuit 11 to control the operation of the atomizing plate 25 of the water tank 20, so that the water or liquid in the containing sink 23 of the water tank 20 can be atomized and sprayed out from the spraying hole 31 of the upper lid 30. In a mean time, the illumination device 17 will display the condition of electricity and operation by a color or flashing. When the battery 121 of the base 10 is low or the water level or liquid level in the containing sink 23 of the water tank 20 descends to a low level that the water or liquid is about to be used up, the control circuit 11 will control the illumination device 17 to notify a user to replace the battery 121 or to add water or liquid to the containing sink 23 of the water tank 20, by a different color, such as red, or by flashing in red.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A mist spraying device comprising:
a base, an interior of the base is provided with a control circuit and a battery chamber, wherein the control circuit is equipped with control functions of atomizing by oscillation, water level sensor and a condition display; the battery chamber is provided with at least a battery to provide the control circuit with required working power by electricity of the battery; a side of the base is provided with a switch which is connected with the control circuit and is pressed down to control the control circuit to activate the control function of atomizing by oscillation, a periphery on a top of the base is provided with an illumination device which is controlled by the control circuit to display a condition of spraying the atomized water or liquid, electricity of the battery or water level, and the top of the base is provided with plural metal junctions which are connected with a power end and a sensor end of the control circuit;
a water tank, the water tank is assembled on the top of the base and a bottom of the water tank is provided with plural conductor junctions, with that the conductor junctions are connected with the metal junctions on the top of the base, an interior of the water tank is provided with a containing sink which holds water or liquid, an interior of the containing sink is provided with a water level sensor to sense water level or liquid level in the containing sink, an exterior of the water tank is provided with an exit which is connected with the containing sink and is assembled with an atomizing plate, wherein the atomizing plate atomizes and outputs water or liquid in the containing sink; the water level sensor and the atomizing plate are connected by wirings with the conductor junctions, so that the water level sensor and the atomizing plate are connected with the metal junctions of the base, thereby enabling the control circuit of the base to control the atomizing plate to operate the atomization of water or liquid by oscillation, and to output a condition of water level or liquid level sensed by the water level sensor to the control circuit; and an upper lid, the upper lid is assembled at the top of the base and covers the exterior of the water tank, with that the upper lid is provided with a spraying hole through which atomized water or liquid outputted from the atomizing plate of the water tank is sprayed out.

2. The mist spraying device according to claim 1, wherein a side of the base is provided with an elastic button, a front side of the base is assembled with a rear cover, and a side of the rear cover forms a latch group with the elastic button.

3. The mist spraying device according to claim 2, wherein a side of the base is provided with plural latch holes, a side of the rear cover is provided with plural claws, and the claws are engaged into the latch holes.

4. The mist spraying device according to claim 1, wherein the illumination device of the base includes a light emitting diode and a light guide plate, and the light emitting diode is connected with the control circuit.

5. The mist spraying device according to claim 1, wherein the top of the base is provided with a latch pole, the bottom of the water tank is provided with a latch opening, and the latch opening is latched and connected with the latch pole of the base.

6. The mist spraying device according to claim 5, wherein two sides of the latch pole are provided respectively with a bump, a periphery of the latch opening is provided with plural openings, and the bumps are latched into the openings.

7. The mist spraying device according to claim 1, wherein a side on the top of the base is provided with a latch slot for latching with a side on the bottom of the water tank.

8. The mist spraying device according to claim 7, wherein the latch slot is in an arc shape.

9. The mist spraying device according to claim 1, wherein a periphery of an exit of the water tank is provided with a seal portion which is assembled with a waterproof washer and a panel.

10. The mist spraying device according to claim 9, wherein the panel is provided with an ejection hole.

11. The mist spraying device according to claim 1, wherein a top of the containing sink of the water tank is provided with a leak-proof hole.

12. The mist spraying device according to claim 11, wherein an interior of the leak-proof hole is assembled with a waterproof gasket.
